(19) United States
(12) Patent Application Publication
(10) Pub. No.: US 2026/0359862 A1
(43) Pub. Date: Nov. 12, 2026

(54) Methods and Systems for Optimal Service Package Determination using Machine Learning

(71) Applicant: T-Mobile Innovations LLC, Overland Park, KS (US)

(72) Inventor: Murugappan PALANIAPPAN, Issaquah, WA (US)

(21) Appl. No.: 19/200,344

(22) Filed: May 6, 2025

(51) Int. Cl. G06Q 30/0251

(52) U.S. Cl. CPC G06Q 30/0255

(57) ABSTRACT

A method comprises training, by a service application, a data model system using historical data describing a transactional history of one or more users, determining, by the service application using a recommendation application executing at the data model system, a service package for the one or more users based on the historical data of the one or more users, simulating, by the service application using a simulation application executing at the data model system, the service package being added to a subscription plan of each of the one or more users for a predefined period of time to determine a cost parameter for each of the one or more users, initiating, by the service application, provisioning of the service package to the subscription plan of a user of the one or more users when the cost parameter for the user exceeds a predefined threshold.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Traditionally, service providers and businesses distribute offers for products and services to customers through broad marketing campaigns. These offers are typically generated solely based on market needs and general customer preferences. Marketing teams may send promotions via email, short message services (SMS), push notifications, or in-app messages to a wide audience, ensuring maximum outreach. In many cases, these offers are static, predefined, and sent to a wide range of customers. As a result, customers often receive offers that may not be relevant to their interests, leading to lower engagement and reduced network capacity.

### SUMMARY

In an embodiment, a method for optimal service package determination and deployment in a communication network is disclosed. The method comprises maintaining, by a service application executing at a service system, historical data describing a transaction history of a user, in which the historical data comprises service package records describing a history of service packages associated with the user and usage records describing at least one of service usage, applied rates, balance adjustments, or session details of the user, and training, by the service application, a data model system to identify a plurality of other users with similar transaction histories as the user, to determine a service package associated with the user and the other users, and to simulate the service package being applied to a subscription plan of the user and the other users using the historical data. The method further comprises forwarding, by the service application, current user parameters to the data model system, and identifying, by the service application using a user grouping application executing at the data model system, the other users with similar transaction histories and current user parameters as the user, in which the similar transaction histories and the current user parameters satisfy a first condition indicated in a user grouping policy for detecting users exhibiting a similar suboptimal performance metric. The method further comprises determining, by the service application using a recommendation application executing at the data model system, the service package to potentially provision in a subscription plan for the user and the other users, in which the service package satisfies a second condition indicated in a service policy for modifying or adding to the subscription plan of the user and the other users, and simulating, by the service application using a simulation application executing at the data model system, provisioning of the service package to the subscription plan for the user and the other users over a predefined period of time to determine a cost parameter for each of the user and the other users, in which the cost parameter is a metric indicative of a projected mitigation of the suboptimal performance metric. The method further comprises transmitting, by the service application, a notification describing the service package to a client associated with the user when the cost parameter for the user exceeds a predefined threshold, and initiating, by the service application, provisioning of the service package to the subscription plan of the user after receiving an indication from a client that the user has accepted the service package.

In another embodiment, a system comprises a non-transitory memory configured to store historical data describing a transaction history of a plurality of users, wherein the historical data comprises service package records describing a history of service packages associated with each of the users and usage records describing at least one of service usage, applied rates, balance adjustments, or session details of each of the users, and store a subscription plan associated with each of the users. The system further comprises a processor communicatively coupled to the memory, a service application stored at the memory, which when executed by the processor, causes the processor to be configured to train a data model system to identify a subset of users with similar transaction histories, to determine a service package associated with the subset of users, and to simulate the service package being applied to a subscription plan of the subset of users using the historical data, identify, using an identification application executing at the data model system, the subset of users with similar transaction histories based on current user parameters associated with the subset of users and first condition indicated in a user grouping policy for detecting users exhibiting a similar suboptimal performance metric, simulate, using a simulation application executing at the data model system, provisioning of the service package to the subscription plan of the subset of users over a predefined period of time to determine a cost parameter for each of the subset of users, in which the cost parameter is a metric indicative of a projected mitigation of the suboptimal performance metric, and initiate provisioning of the service package to the subscription plan of a user when the cost parameter of the user exceeds a predefined threshold and when the user accepts service package.

In yet another embodiment, a method is disclosed. The method comprises training, by a service application executing at a service system in a communication network, a data model system using historical data describing a transactional history of one or more users, determining, by the service application using a recommendation application executing at the data model system, a service package for the one or more users based on the historical data of the one or more users, simulating, by the service application using a simulation application executing at the data model system, the service package being added to a subscription plan of each of the one or more users for a predefined period of time to determine a cost parameter for each of the one or more users, and initiating, by the service application, provisioning of the service package to the subscription plan of a user of the one or more users when the cost parameter for the user exceeds a predefined threshold.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network for optimal service package determination according to an embodiment of the disclosure.

FIG. 2 is a diagram illustrating the training of a data model system in the communication network of FIG. 1 according to various embodiments of the disclosure.

FIG. 3 is a diagram illustrating the use of the different applications in the data model system to predict an optimal service package for one or more users in the communication network of FIG. 1 according to various embodiments of the disclosure.

FIG. 4 is a diagram illustrating the provisioning of the optimal service package for one or more users in the communication network of FIG. 1 according to various embodiments of the disclosure.

FIG. 5 is a flowchart of a first method of optimal service package determination and provisioning according to various embodiments of the disclosure.

FIG. 6 is a flowchart of a second method of optimal service package determination and provisioning according to various embodiments of the disclosure.

FIGS. 7A-B are block diagrams illustrating a communication system similar to the communication network of FIG. 1 according to an embodiment of the disclosure.

FIG. 8 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, service providers and business distribute offers for products and services to users, and these offers may be generated without regard for individual user preferences, usage patterns, or specific needs. Said another way, these offers are not dynamically tailored based on actual user data. Instead, the offers are more generic, such that the same offer for the same service, for example, may be sent to hundreds of users who all have vastly different interests and behavioral patterns.

The lack of intelligence involved in offer distribution to customers results in several technical problems. For example, since the same offers are sent to all users without considering real-time usage data, network conditions, or subscriber preferences, many users may not engage with these offers (the offers may not be relevant to the user's actual needs). Moreover, since the offers are sent indiscriminately to a large number of users, network resources such as message infrastructure (e.g., short message service (SMS) gateways, push notification servers, etc.) and backend processing systems handle unnecessary traffic. This in turn increases latency, processing loads, and operational costs at the network of the service provider. Mass offer distribution methods, particularly bulk SMS, email, and push notifications, may also expose users to phishing attacks, fraud, or spam-like experiences. Therefore, generically sending offers to numerous users without regard to whether the customer may actually engage with the offer, much less accept the offer, greatly reduces network capacity and security.

The present disclosure addresses the foregoing technical problems by providing a technical solution in the technical field of network management. Specifically, the embodiments disclosed herein address the inefficiencies with service offer distribution by introducing a system-driven, machine-learning leveraged approach for dynamically determining and provisioning service packages to users based on real-time user attributes and behaviors, historical user behaviors, and policy-based decisioning. The term “service package” as used herein refers to an offer for a new service, a modification of a service, and/or an add-on service that may be added to a subscription plan, parameter, or user account of the user.

Unlike methods that rely on static, non-personalized promotions, the disclosed system leverages data-driven analysis to identity relevant service modifications, optimizations, and/or add-ons tailored to individual users. By integrating automated provisioning mechanisms and machine-learning with the core network, the system also ensures efficient allocation of resources while improving service accessibility and cost-effectiveness for users. Significantly, the embodiments disclosed herein reduce unnecessary network traffic, enhance billing accuracy, and minimize service disruptions by dynamically modifying user subscription parameters in response to user-specific conditions and policy-based thresholds. As a result, the disclosed system provides a scalable, adaptive framework for delivering service enhancements while overcoming limitations of static offer distributions.

A communication network used for optimal service package determination and provisioning may include a client (operated by a user/subscriber of a telecommunication service provider (TSP)), a data model system running one or more machine learning models and associated algorithms, one or more data stores storing data that may be used to train and used as input to the data model system, a core network system, and a service system. The core network system refers to a centralized telecommunications infrastructure operated by the TSP that manages user data and communications. The service system may store various policies and run a service application that may use the data model system, locally stored policies, and data from the data stores to perform the methods for optimal service package determination and provisioning disclosed herein.

The one or more data stores may maintain data collected over time describing a transaction history of different users that are, for example, subscribers of the TSP. For example, the data stores may store historical data including transaction records, rating data, subscription balance data, and other data related to the transactions, billing, charging, etc. associated with the users. The transaction records may include service package records describing a history of service packages associated with each user and usage records, which may include logs capture subscriber service usage details. The rating data may include pricing information applied to services and service packages, and the subscription balance data may include real-time account balance adjustments, including data quota updates. The data store may store user identification data and a current subscription plan in association with the transaction records, rating data, and subscription balance data associated with each user.

The aforementioned data may be collected from various data sources within the core network system. For example, the data sources in the core network system from which the aforementioned data may be obtained include a network provisioning entity (NPE) (responsible for initiating subscription and account modifications), a call handling function (CHF), a charging system (CS), and a network service manager (NSM), as further described herein. The NPE may maintain a comprehensive catalog (“NPE catalog”) of subscription packages (e.g., subscription plans/modifications/add-ons) and manage user profiles by translating user transactions—such as, for example, account creation, adding a line, or add-on—into specific configuration settings for core network elements. The NPE may also log every transaction to ensure the user profile remains accurate and up-to-date in an NPE provisioning log. The CHF may oversee call signaling, including call setup, routing, and teardown, and data session establishment, use, and tear down, to create robust call detail records (CDRs) for each transaction performed by each user. The CS tracks and processes billing information by recording usage data and applying appropriate rating policies to subscriber activities, and may log transactions and subscription balances of each user in real-time (e.g., into CS metered data and/or query logs). The NSM may monitor and manage network services and customer sessions by proactively diagnosing issues, implementing service changes, and facilitating customer care operations. The NSM may also monitor and manage all tasks performed in relation to the monitoring and managing in network usage records and NSM logs. In this way, the transaction records, service package records, usage records, rating data, subscription balance data, user identification data, and subscription plans may be pulled from the CDRs, CS metered data, query logs, NPE catalog, NPE provisioning logs, network usage records, and NSM logs stored at the NPE, CHF, CS, and NSM.

The service system may include a service application that may communicate with the data stores across the core network system and use the data model system to determine optimized service packages for one or more users. The service system may also include a data store that stores subscription plans for one or more users that, for example, opt-in to receive the benefit of receiving offers for optimally determined subscription packages. The data store at the service system may also store various policies that include logic, code, and/or rules for using the data model system to perform tasks in relation to determining and provisioning optimized service packages for users. The policies may include, for example, an identification policy, a user grouping policy, a service policy, and a modification policy, each including logic or code defining conditions for outputting data, as further described below.

The data model system may be a collection of one or more servers or computer systems communicatively coupled to the service system. The data model system may be a computational system (e.g., including both software and hardware components) designed to make predictions or forecasts based on patterns learned from the aforementioned the historical data and other data provided as input into the data model system. As further described herein, the data model system may run one or more machine learning models (with corresponding algorithms, parameters, and weights) may predict an optimal service package to suggest to a user based on analysis of past and historical transactions and behavioral patterns associated with the user. The data model system may include various applications, each running respective algorithms, parameters, and weights, and each being tailored to output predefined types of data based on the input data of the respective application. For example, the data model system may include an identification application, a user grouping application, a recommendation application, and a modification application. Each of the applications may be respectively trained based on historical data and subscription data related to users (obtained from the aforementioned data stores in the core network system).

To train the applications at the data model system, the service application at the service system may provide and collect the historical data describing a transactional history of numerous users (e.g., in the hundreds, thousands, or millions) from the data stores in the core network system historically over a predefined period of time. The service application may then provide this data as input training data to train the identification application, user grouping application, recommendation application, and modification application executing at the data model system. This training data may be provided to the identification application as labelled datasets or unlabeled datasets. As such, multiple layers of labeled and/or unlabeled data (e.g., the historical data and the policies), and an enormous amount of this data, are being used to train the machine learning models at the data model system to determine optimal service packages for the identified users.

The service application may also provide one or more identification policies to the identification application to program the algorithms of the identification application according to the identification policies. The identification policy may include logic or code defining one or more conditions, which when satisfied, may instruct the service application (e.g., using an identification application executing at the data model system) to identify a user exhibiting at least one suboptimal performance metric with respect to a user or network attribute (compared to other users with similar transactional history data that may have a higher performance metric with respect to the same attribute). In this way, the identification application may be used to identify a user exhibiting a suboptimal performance metric as defined by an identification policy (i.e., the identification application may output an identifier of the identified user).

The service application may also provide one or more user grouping policies to the user grouping application to program the algorithms of the user grouping application according to the user grouping policies. The user grouping policy may include logic or code defining one or more conditions, which when satisfied, may instruct the service application (e.g., using a user grouping application executing at the data model system) to group multiple users together with the identified user based on the users all exhibiting similar suboptimal performance metrics (and having similar transactional history data). In this way, the user grouping application may be used to identify numerous other users exhibiting the same suboptimal performance metric (i.e., the user grouping application may output identifiers of all the identified users).

The service application may also provide one or more service policies to the recommendation application to program the algorithms of the recommendation application according to the service policies. The service policy may include logic or code defining one or more conditions, which when satisfied, may instruct the service application (e.g., using a recommendation application executing at the data model system) to determine a service package to recommend for the users, in which the service package may be determined to mitigate the inefficiencies caused to the user and/or the network by the suboptimal performance metric associated with the user. For example, certain predefined subscription packages may have a history of reducing network latencies, reducing user costs, increasing bandwidth, etc. In this way, the recommendation application may be used to determine the service package that may mitigate the suboptimal performance metric of the users (i.e., the recommendation application may output service package data describing the service package).

The service application may also provide one or more modification policies to the modification application to program the algorithms of the modification application according to the modification policies. The modification policy may include logic or code defining one or more conditions, which when satisfied, may instruct the service application (e.g., using a simulation application executing at the data model system) to simulate adding the service package to subscription plans/user accounts of the users to determine cost parameters for each of the users. The cost parameter may refer to a metric indicative of a projected amount of mitigation of a network or user attribute when the service package is added to subscription plans/user accounts of the users. In this way, the simulation application may be used to determine the cost parameters (e.g., network and/or user savings) associated with each of the users if the user was to subscribe to the determined service package (i.e., the modification application may output the cost parameters (e.g., a value) for each of the users).

Therefore, each of the applications at the data model system may be programmed with policies that may be trained using the vast amount of data collected over time to identify patterns and terms, select the appropriate machine learning algorithm for each context or use case based on the input source data (current user parameters), and determine which of the users to which to recommend the service package. For example, during training, the algorithms at the data model system may update the parameters and weights through processes such as gradient descent, adjusting weights and biases based on the input training data to minimize errors in the predictions. The data model system may then be used to determine one or more users exhibiting suboptimal performance, identify a service package to recommend to the users to potentially increase the suboptimal performance, and determine which of the users to which to recommend the service package to based on various thresholds and policies.

Once the machine learning algorithms and algorithms at the data model system have been trained, the service application executing at the service system may continuously or intermittently (e.g., based on a predefined schedule) input current user parameters into the data model system. The current network parameters may include the most recently collected CDRs, CS metered data, query logs, NPE catalog, NPE provisioning logs, network usage records, and NSM logs from one or more core network elements (e.g., NPE, CHF, CS, and NSM), describing the transactions and behaviors of the users.

As an example, suppose that certain users are invoiced at a greater amount for international long distance calls when compared to other users, even though all of these users have approximately the same range of long distance call minutes per month. This may be because the users who are invoiced less may have subscribed to an add-on feature (e.g., a subscription package) that reduces the overall costs for international long distance calls (even though the add-on feature has a yearly/monthly cost). The current user parameters that are periodically or persistently fed to the data model application as input data may indicate, over time, that certain users are paying more than other users for international long distance calls. The identification application at the data model system may use an identification policy to identify a user that is paying more for international long distance calls than other users. For example, the identification policy may include logic or code defining a condition in which a user is operating at a suboptimal performance metric because the user is paying more for international long distance calls than other users who have similar international long distance call minutes.

The user grouping application executing at the data model system may use a user grouping policy to identify other users who are also paying more for international long distance calls. The user grouping policy may include logic or code defining a condition to identify multiple users with similar transactional records in the current user parameters, indicating that the users are also operating at the suboptimal performance metric and paying more for international long distance calls than other users who have similar international long distance call minutes.

The recommendation application executing at the data model system may use a service policy to determine a service package that may increase the performance metric related to the international long distance calls made by the users exhibiting suboptimal performance. The service policy may include logic or code defining a condition for determining an optimal service package for the users identified as having the suboptimal performance metric. For example, the recommendation application may be trained to identify certain subscription packages as improving performance metrics based on historical data across subscriptions of numerous different users. This service package may be, for example, the add-on feature that lower the overall cost for international long distance calls for certain users (e.g., as determined based on the current network parameters and the existing subscription plans of the users).

The simulation application executing at the data model system may use a modification policy to simulate the addition of the identified service package to the subscription plans of each of the identified users to determine a cost parameter for each user. The modification policy may include logic or code defining a period of time over which to simulate the addition of the service package (e.g., over 6 months), which may be based on various factors, such as, for example, the suboptimal performance metric. The simulation application may then simulate the addition of the service package to the subscription plan of each of the users for the determined period of time to determine the cost parameter, or total cost savings, for each of the users, and validate the cost parameter for each user (e.g., based on an averaging the cost parameter per month).

The service application may use the cost parameters and the modification policy to determine whether to transmit a notification with service package data describing the service package to one or more of the identified users. For example, the modification policy may include one or more thresholds (which may be dynamically defined based on different contexts, different performance metrics, etc.), such that when a cost parameter for a user is greater than (or less than) a threshold, the service application may be instructed to transmit the notification with the service package data to the user.

A client of the user may display the service package data describing the offer after receiving the notification. The user may interact with the notification via a user interface to either express interest in the service package (e.g., click a link to learn more), accept the recommended service package (e.g., click a link to add the service package to the subscription plan of the user), or reject the recommended service package. Each type of interaction may be associated with a weight parameter, which may represent an accuracy of the recommended service package (e.g., a weight parameter of a user having accepted the service package may be higher than a weight parameter of a user having only expressed interest to learn more about the service package). The weight parameter may be sent back to the data model system as feedback data to retrain the algorithms, weights, and/or parameters of the different algorithms of the machine learning model. In this way, the applications and algorithms at the data model system are continuously trained and updated (i.e., as the data model system learns with more feedback data over time) to more accurately predict service packages for users over time.

When accepted, the service application executing at the service system may communicate with the NPE to provision the subscription package for the user at the core network system. In this way, embodiments disclosed herein ensure that only the most relevant service package offers are presented to users, based on a robust and up-to-date analysis of historical user data and current user data. By ensuring that only relevant service package offers are presented to users, the network may no longer be flooded with indiscriminate offers that are batch sent to numerous users. This in turn increases network capacity and efficiencies across the entire span of the network.

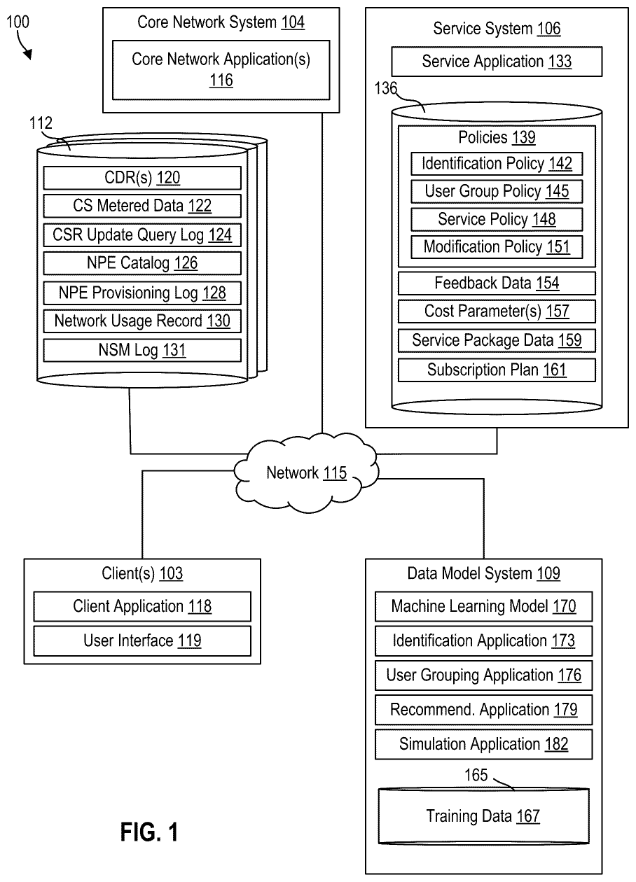

Turning now to FIG. 1, a communication network 100 is described. The communication network 100 includes a client 103, a core network system 104, a service system 106, a data model system 109, one or more data stores 112, and a network 115. The network 115 may be one or more private networks, one or more public networks, or a combination thereof. While the core network system 104, service system 106, data model system 109, and data stores 112 are shown as separate from the network 115 in FIG. 1, it should be appreciated that the core network system 104, service system 106, data model system 109, and data stores 112 may be included as part of the network 115 in various embodiments.

The clients 103 may refer to computing or communication devices that receive offers for subscription packages from the service system 106 via the core network system 104. These clients 103 may be operated by subscribers of a telecommunications service provider (TSP) and may be, for example, user equipment (UE) such as smartphones, tablets, Internet of Things (IoT) devices, or other network-connected terminals. Data regarding the clients 103, including their subscription entitlements, service configurations, and network policies, may be stored in association with corresponding subscriber lines at a subscription data store of the core network system 104.

The client application 118 may include instructions stored on a memory of a client 103 and executable by a processor of the client 103. The client application 118 may receive notifications from the service system 106 and present data regarding recommended service packages on a display of the client 103. A user may interact with the displayed data via a user interface 119 of the client 103 to express interest in learning more about the recommended service package, accept the recommended service package, or decline the recommend service package.

The core network system 104 may be the central telecommunications infrastructure responsible for managing key telecommunications functions and services, such as, for example, call control, data routing, mobility management, and service delivery across the communication network 100. The core network system 104 may connect various access networks (e.g., mobile, fixed) to external networks, such as the Internet, and handles tasks, such as authentication, policy enforcement, and quality of service for clients 103 using one or more core network applications 116. The core network applications 116 may be stored across one or more memories and executable by one or more processors. For example, when the core network system 104 supports a 5^{th} Generation (5G) technology standard for cellular networks, the core network applications 116 may include an access and mobility management function (AMF), a session management function (SMF), a policy control function (PCF), user plane functions (UPFs), unified data management (UDM), etc. The core network system 114 may include or be connected to a radio access network (RAN), which may connect clients 103 to the core network system 104. The RAN may include one or more cell sites, base stations, antennas, and other hardware nodes (e.g., routers, switches, bridges, virtual networks, etc.) that manage the transmission and reception of wireless signals. For example, a client 103 may connect to the network 115 via a cell site to access services and communicate with the core network system 104 via the RAN.

The service system 106 may be system (e.g., a set of servers including a collection of memory, processing, and communication resources) responsible for determining one or more optimal service packages for one or more users and provisioning or deploying the service packages in a subscription plan of selected users based on various policies. The service system 106 may include a service application 133 stored on a memory of the service system 106 and executable by a processor of the service system 106. As described herein, the service application 133 may communicate with the data model system 109 to perform the methods described herein.

The service system 106 may also include a data store 136 (e.g., one or more distributed or co-located memories) for storing data that may be used by the service application 133 to perform the operations discussed herein. For example, the data store 136 may store one or more policies 139, feedback data 154, cost parameters 157, service package data 159, and a subscription plan 161 of one or more users (e.g., subscribers of the TSP operating the service system 106).

The policies 139 may each refer to logic or code defining one or more conditions that, when satisfied, may instruct the service application 133 to perform one or more predefined tasks or operations (in some cases, by communicating with and/or using one or more applications at the data model system 109). The policies 139 may include, for example, an identification policy 142, a user grouping policy 145 (shown in FIG. 1 as “user group policy 145”), a service policy 148, and a modification policy 151. The identification policy 142 may include logic or code defining one or more conditions, which when satisfied, may instruct the service application 133 (in some cases, using an identification application 173 at the data model system 109) to identify at least one user exhibiting a suboptimal performance metric with respect to a network or user attribute (when compared to other users with similar transactional history data that may have a higher performance metric with respect to the same network or user attribute).

A performance metric may refer to a measured indicator associated with a network attribute or a user attribute. A network attribute may refer to a characteristic related to a quality of performance at an element in a network or across the network (e.g., latency, throughput, bandwidth, jitter, network traffic, security, packet loss, error rate, round-trip time, etc. A user attribute may refer to a characteristic related to a customer experience (e.g., incurred costs, delays, etc.).

For example, the performance metric may be a value representing a cost incurred by the user for a particular service offered by the TSP (e.g., a user attribute, as indicated in an invoice presented to the user), a latency experienced by the user for the service (e.g., network attribute), degraded data throughput experience by the user in relation to the service (e.g., network attribute), inefficient resource allocations while providing the service to the user (e.g., network attribute), policy misconfigurations that occur as a result of providing the service to the user (e.g., network attribute), higher than expected service consumption patterns during a session for the service (e.g., user attribute), etc. For example, the service application 133 may perform system-monitored evaluations based on various rules to compute the performance metric for various users with respect to certain services provided by the TSP. The suboptimal performance metric mentioned above may refer to the performance metrics that deviate from a predefined operational threshold, signaling high costs incurred by the user and/or inefficiencies in service delivery, network utilization, and/or subscriber experience.

The user grouping policy 145 may include logic or code defining one or more conditions, which when satisfied, may instruct the service application 133 (e.g., in some cases, using a user grouping application 176 executing at the data model system 109) to group multiple users together with the identified user mentioned above based on the users all exhibiting similar a suboptimal performance metric (and having similar transactional history data with respect to the performance metric). The service policy 148 may include logic or code defining one or more conditions, which when satisfied, may instruct the service application 133 (e.g., in some cases, using a recommendation application 179 executing at the data model system 109) to determine a service package to recommend for the users, in which the service package may increase the performance metrics associated with the users. The service package may refer to a new service, service modification, or add-on feature available to a user that is a subscriber with a subscription plan 161 (e.g., such that the service package can be added to the subscription plan 161 and provisioned at the core network system 104 if accepted/purchased by a user). The service package data 159 may include data describing the determined service package that may be sent to clients 103 and used by the clients 103 to generate a displayable representation of the service package as an offer to the user. For example, the service package data 159 may include details regarding the service package, including metadata such as pricing, validity period, eligibility criteria, and network provisioning parameters to facilitate user interaction and selection.

The modification policy 151 may include logic or code defining one or more conditions, which when satisfied, may instruct the service application 133 (e.g., using a simulation application 182 executing at the data model system 109) to simulate adding the service package to subscription plans 161 of the users to determine cost parameters 157 for each of the users. The cost parameter 157 may refer to a metric indicative of a projected correction to the performance metric that was previously considered suboptimal (e.g., a reduction in at least one of costs incurred or use of network resources, a reduction in the latencies experienced with respect to the performance metric, etc.) if the user were to add the service package to the subscription plan 161 of the user. In some embodiments, the cost parameter 157 may refer the savings that may be experienced by the user or the network when the user subscribes to the determined service package.

The subscription plan 161 of a user refers to a predefined set of entitlements, policies, and service configurations associated with an account of a user within a TSP network. When an offer for a service package is accepted at a client 103, the service package data 159 may be incorporated in the subscription plan 161 of the user, in which the relevant parameters such as available services, pricing, and policy rules are updated. The upgraded subscription plan 161 may then be provisioned at the core network system 104 by modifying records in core network applications 116, such as the unified data management (UDM), policy control function (PCF), and online charging system (OCS), to enablement enforcement of the attributes of the service package.

When the user expresses interest in the offer for the service package, accepts the offer for the service package, or rejects the offer for the service package at the client 103 via the user interface 119, the client application 118 may generate feedback data 154 and transmit that feedback data 154 to the service system 106. The feedback data 154 may include certain weight parameters (e.g., values) representing a level of interest in the offer for the service package, which may thus represent an accuracy of the recommended service package for the user. For example, the weight parameter may be lowest when the user rejects the offer for the service package, and the weight parameter may be highest when the user accepts the offer for the service package. When the user only expresses interest in the service package (e.g., by selecting a link to view more details regarding the service package), the weight parameter may be a value in the middle between the aforementioned weight parameters. The feedback data 154 may then be sent to the data model system 109 to retrain the algorithms, weights, parameters, and applications at the data model system 109 based on the accuracy of the recommendation as indicated in the feedback data 154.

The data model system 109 may be implemented as a server or computer system, including one or more processors and memories storing instructions associated with a machine learning model 170, an identification application 173, a user grouping application 176, a recommendation application 179, and a simulation application 182. The machine learning model 170 may work with the identification application 173, user grouping application 176, recommendation application 179, and simulation application 182 and leverage algorithms and statistical techniques to analyze input features of and identify patterns to determine optimal service packages for users. The machine learning model 170 may be implemented using software (e.g., algorithms, logic, and code) stored across one or more memories, and the underlying hardware of the data model system 109 may provide the computational resources for execution of the machine learning model 170. The machine learning model 170 may be implemented as one or more different types of models using, for example, linear regression, decision trees, support vector machines, neural networks, or ensemble methods. It should be appreciated that any type of machine learning model 170 may be used, and the underlying algorithms, computations, and machine learning libraries used by the model should not be limited herein.

The identification application 173, user grouping application 176, recommendation application 179, and simulation application 182 may each be instructions stored across one or more memories of the data model system 109 that may be executable by one or more processors of the data model system 109. The identification application 173 may be trained to identify a user with at least one suboptimal performance metric using an identification policy 142. The user grouping application 176 may be trained to identify users similar to the identified user with similar suboptimal performance metrics using a user grouping policy 145. The recommendation application 179 may be trained to identify a service package that may mitigate the suboptimal performance metric across the identified users using the service policy 148. The simulation application 182 may be trained to simulate the application of the service package to the subscription plan 161 of the identified users to determine cost parameters 157 using a modification policy 151.

The data model system 109 may also include a data store 165 (e.g., one or more distributed or co-located memories). The data store 165 may store training data 167 that may be used to train the machine learning model 170, identification application 173, user grouping application 176, recommendation application 179, and simulation application 182. The training data 167 may be data collected from one or more data stores 112 over an extended period of time (e.g., and may include data describing a transaction history of numerous different users).

The data stores 112 may be a collection of one or more memories (co-located or distributed across different data centers), which are accessible by the service system 106. The data stores 112 may be included with elements the core network system 104 or external to the core network system 104. The data stores 112 may be accessible by the service application 133 of the service system 106. As shown in FIG. 1, the data store 112 may store CDRs 120, CS metered data 122, CSR update query logs 124, NPE catalogs 126, NPE provisioning logs 128, network usage records 130, and NSM logs 131 (among other types of data). Each of the data types listed above may be obtained from various core network applications 116 or elements, such as, for example, the NPE, CHF, CS, CSCF, AMF, SMF, UPF, etc.

The CDRs 120 may capture transactional details related to a user's service usage, including session duration, consumed data volume, and associated charging events, enabling accurate billing and policy enforcement. The CS metered data 122 may refer to real-time service consumption metrics monitored by the charging system (CS) to regulate quota allocations, track usage thresholds, and enforce service limitations. The CSR update query logs 124 may refer to document modifications or retrievals of Charging Subscription Records (CSRs), reflecting updates to user entitlements, policy enforcement parameters, or balance adjustments in response to service changes. The NPE catalogs 126 store predefined service provisioning rules, policy-driven configurations, and eligibility criteria that the NPE (a core network application 116) may reference when determining how to activate or modify a service package for a user. The NPE provisioning logs 128 may record provisioning actions performed by the NPE, including service activations, parameter modifications, and network function interactions to ensure accurate deployment of subscription changes. The network usage records 130 may contain aggregated statistics on a user's data, voice, and messaging activity, providing insights into resource consumption patterns and service performance. The network session management (NSM) logs 131 may capture details related to events associated with the establishment, modification, and termination of user sessions within the core network system 104, for example, detailing interactions with SMF and PCF in the core network system 104 to facilitate dynamic service adjustments.

While the data stores 112, core network system 104, service system 106, and data model system 109 are shown in FIG. 1 as being separate from one another, one or more of the data stores 112, core network system 104, service system 106, and data model system 109 may be physically or logically together across a single (co-located or distributed) set of servers. For example, the data stores 112 and the service system 106 may be part of the core network system 104, or the data stores 112 and/or the service system 106 may be separate from the core network system 104. The data model system 109 may be part of the service system 106 and/or core network system 104, or the data model system 109 may be separate from the service system 106 and/or core network system 104.

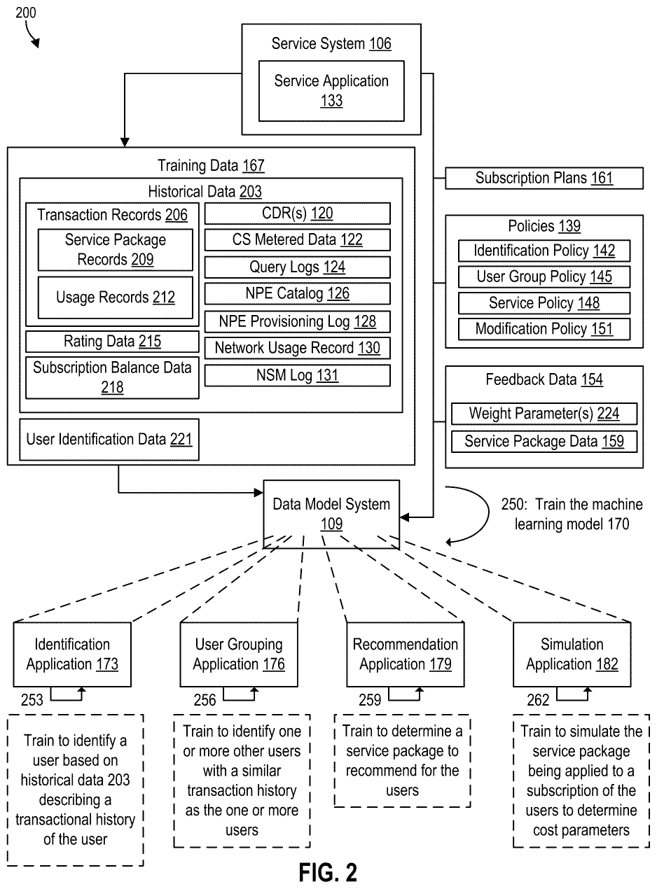

Referring now to FIG. 2, shown is a diagram illustrating the training of the data model system 109 according to various embodiments of the disclosure. As shown in FIG. 2 and described above, the data model system 109 includes the identification application 173, the user grouping application 176, the recommendation application 179, and the simulation application 182.

The service application 133 at the service system 106 may provide training data 167 and other data to the data model system 109 to perform operation 250 to training the machine learning model 170. More specifically, the training data 167 and other data may be used to train the identification application 173, the user grouping application 176, the recommendation application 179, and the simulation application 182 at the data model system 109, each of which may operate using the algorithms, parameters, weights, etc., of the machine learning models 170 programmed at the data model system 109.

The training data 167 includes historical data 203 describing a transaction history of numerous users (subscribers of the TSP) that have or may have had subscription plans 161 with the TSP. The historical data 203 includes transaction records 206 describing the transaction history of the users, rating data 215, and subscription balance data 218. The historical data 203 may also include the CDRs 120, CS metered data 122, CSR update query logs 124, NPE catalogs 126, NPE provisioning logs 128, network usage records 130, and NSM logs 131, each of which may be collected from the data stores 112 over a predefined amount of time in the past (e.g., enough time for the machine learning model 170 to identify patterns and trends for service package recommendation). The transaction records 206, rating data 215, and subscription balance data 218 may include data that is obtained (e.g., received or generated) based on the CDRs 120, CS metered data 122, CSR update query logs 124, NPE catalogs 126, NPE provisioning logs 128, network usage records 130, and NSM logs 131 collected from the data stores 112 over time.

The transaction records 206 may include service package records 209 describing a history of service packages associated with each user (e.g., the service packages included in a subscription plan 161 of the user, service packages previously rejected by the user, service packages removed from the subscription plan 161 of the user, etc.). The transaction records 206 may also include usage records 212, which may include logs capturing user service usage details (e.g., voice calls, data usage, long distance calls, roaming calls, etc.), and session details for real-time charging, postpaid billing, policy enforcement, etc. The rating data 215 may include pricing information applied to services and service packages consumed by the users (including discounts, promotions, and tiered pricing, etc.), and may indicate a cost per unit of service (e.g., per minute, per message, per megabyte (MB), etc.). The subscription balance data 218 may include real-time account balance adjustments, including data quota updates (e.g., the amount of data remaining for usage in the subscription), credit deductions, renewal transactions, etc., and may be used to ensure prepaid users do not exceed the available balance. The training data 167 may also include user identification data 221 (e.g., user identifier, account identifier, etc.) to associate the different instances of historical data 203 with specific users.

The other data that may be provided to the data model system 109 to perform operation 250 to train the machine learning model 170 may include the subscription plans 161, the policies 139, and the feedback data 154 maintained at the service system 106. The subscription plans 161 may include data regarding the current subscribed for subscription packages for each of the users. The policies 139 provided to the data model system 109 may include the identification policies 142, user grouping policies 145, service policies 148, and modification policies 151 described above. The feedback data 154 may indicate the accuracy of recommending different service packages to different users. For example, the feedback data 154 for a user may include the service package data 159 describing the service package(s) offered to the user and a weight parameter 224 including a value indicating a level of interest expressed by the user. For example, the weight parameter 224 may be 0 if the user rejected the service package, the weight parameter 225 may be 0.5 if the user clicked a link to view more details on the service package (but has not accepted the service package for purchase yet), and the weight parameter 225 may be 1 if the user accepted the service package for purchase.

At operation 250, the algorithms, weights, and other parameters of the machine learning model 170 at the data model system 109 may be trained (or retrained) based on the training data 167, subscription plans 161, policies 139, and/or feedback data 154 provided as input into the data model system 109. In particular, each of the identification application 173, user grouping application 176, recommendation application 179, and simulation application 182 may be programmatically trained based on the relevant training data 167. For instance, each of the identification application 173, user grouping application 176, recommendation application 179, and simulation application 182 may be associated with one or more machine learning algorithms (each programmed differently to output predictions with higher confidence scores based on the particular type of input data provided). The training data 167, subscription plans 161, policies 139, and/or feedback data 154 may be used to train each of the one or more machine learning algorithms associated with each of the identification application 173, user grouping application 176, recommendation application 179, and simulation application 182 in different manners, such that different algorithms may be selected dynamically based on input data to produce better prediction results based on the input data type.

At operation 253, the identification application 173 may be trained to identify a user based on the training data 167, and in some cases, specifically the historical data 203 describing a transactional history of the user. The identification application 173 may be trained to identify the users based on the identification policies 142 received from the service application 133. Once trained, the identification application 173 may be used to identify a user exhibiting a suboptimal performance metric as defining by an identification policy 142 (based on a historical data 203 of the user). For example, the identification application 173 may be trained to output user identification data 221 (e.g., a user identifier, account identifier, etc.) of the identified user exhibiting a suboptimal performance metric. In some cases, the user identified by the identification application 173 may have opted-in for services related to the methods of recommending optimal service packages, as disclosed herein.

At operation 256, the user grouping application 176 may be trained to identify one or more users (similar to the user identified by the identification application 173) based on the training data 167, and in some cases, specifically the historical data 203 describing a transactional history of the user. The user grouping application 176 may be trained to identify one or more similar users exhibiting the same or a substantially similar suboptimal performance metric. The user grouping application 176 may be trained to identify the similar users based on the user grouping policies 145 received from the service application 133. For example, the users identified by the user grouping application 176 may not only be associated the same suboptimal performance metric, but these users may have substantially similar usage records 212 as the user identified by the identification application 173 (i.e., indicating that the users and the user have similar rates of service consumption-data, voice, messaging, long distance calls, roaming, etc.-over a set period of time). Once trained, the user grouping application 176 may be used to identify numerous other users exhibiting the same suboptimal performance metric (based on a historical data 203 associated with the users). For example, the user grouping application 176 may be trained to output user identification data 221 (e.g., a user identifier, account identifier, etc.) of the identified users exhibiting similar suboptimal performance metrics.

At operation 259, the recommendation application 179 may be trained to determine a service package to recommend for the users (including the user identified by the identification application 173 and the users identified by the user grouping application 176) based on the training data 167, feedback data 154, and/or subscription plans 161 of the users. The recommendation application 179 may be trained to determine one or more service packages to potentially recommend to the users based on the service policies 148 received from the service application 133. For example, a service policy 148 may indicate that certain predefined suboptimal performance metrics (e.g., high costs associated with long distance calls, latencies associated with repeatedly meeting maximum usage criterion/missing payments/rate plan changes, etc.) may be associated with one or more service packages that may help mitigate or resolve inefficiencies caused by the suboptimal performance metric. Once trained, the recommendation application 179 may be used to determine the service package that may at least mitigate the suboptimal performance metric of the users. For example, the recommendation application 179 may be trained to output service package data 159 describing the determined service package.

At operation 262, the simulation application 182 may be trained to simulate the service package being applied to a subscription plan 161 of each of the users to determine a cost parameter 157 for each of the users using the training data 167, feedback data 154, and/or subscription plans 161 of the users. For example, the simulation application 182 may user the historical data 203 (e.g., the usage records 212) over a predefined period of time in the past for each of the users to simulate the addition of the service package to the subscription plan 161 of each of the users. The simulation may be performed over a period of time that is determined dynamically to not only determine how the addition of the service package to the subscription plan 161 may reduce the inefficiencies caused by the suboptimal performance metric, but also validate the determination (by performing the simulation over several consecutive months).

The simulation application 182 may be trained to perform the simulation for the users based on one or more modification policies 151 received from the service application 133. For example, a modification policy 151 may instruct the simulation application 182 to simulate the service package being added to a subscription plan 161 based on a predefined amount of time, in which the predefined amount of time may be based on the suboptimal performance metric detected for the user and a time period that may be sufficient to both determine and validate the cost parameter 157 for each user. Once trained, the simulation application 182 may determine the cost parameters 157 of each of the users based on the simulation of adding the service package to the subscription plans 161 of the users. For example, the simulation application 182 may be trained to output the cost parameters 157 for each of the users. In some embodiments, the service application 133 may receive the cost parameters 157 for each of the users, and compare the cost parameters 157 with a threshold defined in a modification policy 151 to determine whether to recommend the service package for a user.

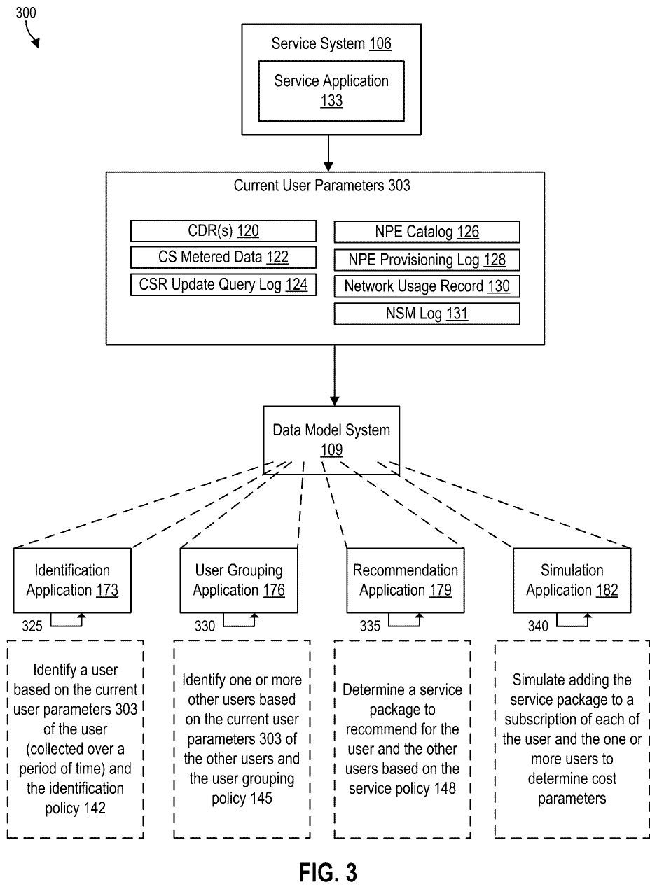

Referring now to FIG. 3, shown is a diagram illustrating the use of the different applications in the data model system 109 to predict an optimal service package for a user according to various embodiments of the disclosure. The service application 133 at the service system 106 gathers current user parameters 303, describing current data associated with the current transactions and activities of the users.

The current user parameters 303 may include data obtained from the CDRs 120, CS metered data 122, CSR update query logs 124, NPE catalogs 126, NPE provisioning logs 128, network usage records 130, and NSM logs 131 collected from the data stores 112 in real-time. The service application 133 may then transmit this data to the data model system 109 (continuously or based on a predefined schedule).

In this way, the current usage parameters 303 may refer to an updated set of user-specific data (including data obtained from the CDRs 120, CS metered data 122, CSR update query logs 124, NPE catalogs 126, NPE provisioning logs 128, network usage records 130, and NSM logs 131). The current usage parameters 303 collectively provide a comprehensive snapshot of the user's service interactions, network resource consumption, and provisioning history. The data model system 109 may receive the current user parameters 303 as input through an automated data pipeline that aggregates, normalizes, and structures the information for analysis. The identification application 173, user grouping application 176, recommendation application 179, and simulation application 182 may continuously learn from updated usage parameters and feedback data 154. In this way, the identification application 173, user grouping application 176, recommendation application 179, and simulation application 182 may continuously refine the predictive accuracy to adapt to evolving network conditions and user behaviors.

The data model system 109 may first filter the current network parameters 303 (and remove unnecessary or unrelated data items) to obtain filtered current network parameters 303. For example, the filtering operation may be performed on a user-by-user basis (to evaluate the performance metrics on a user-by-user basis, while filtering out other users) or a performance metric basis (to focus on an individual detected suboptimal metric, while filtering out users having other types of detected suboptimal metrics).

The service application 133 may use the identification application 173 to perform operation 325, to identify a user based on the current user parameters 303 of the user (collected over a period of time) and an identification policy 142. Again, the identification application 173 may be trained to identify a user exhibiting a suboptimal performance metric based on an evaluation of the current user parameters 303. The identification policy 142 may define thresholds for determining whether the users exhibit a suboptimal performance metric.

As a first illustrative example, an international long distance call use case is described. In this use case, the service application 133 may use the identification application 173 and an identification policy 142 to identify a user (one or more users) that is paying at least a threshold amount more for a minutes-per-month range of international long distance calls compared to a subset of other users that are paying less than the threshold amount for the same minutes-per-month range of international long distance calls. The identification policy 142 applicable to this use case may define the threshold and the minutes-per-month range, in association with the context of international long distance calls. The suboptimal performance metric applicable to this use case is the payment or cost incurred by the user for the time-per-month range of international long distance calls.

As a second illustrative example, a maximum data usage use case is described. In this use case, the service application 133 may use the identification application 173 and identification policy 142 to identify a user (one or more users) that is repeatedly exceeding a maximum allotted data usage amount for the user over a predefined period of time over a threshold frequency, as indicated in the current user parameters 303 and the subscription plan 161. The identification policy 142 applicable to this use case may define the threshold frequency in which the user repeatedly exceeds the allotted data usage amount for the user over the predefined period of time. The suboptimal performance metric applicable to this use case may be the latencies incurred for repeatedly exceeding the maximum allotted data usage amount.

As a third illustrative example, a missed payment use case is described. In this use case, the service application 133 may use the identification application 173 and an identification policy 142 to identify a user (one or more users) that has repeatedly missed payments of invoices (and in some cases, had a suspended account) over a predefined period of time above a threshold frequency, as indicated in the current user parameters 303 of the user. The identification policy 142 applicable to this use case may define the threshold frequency in which the user has repeatedly missed invoice payments over the predefined period of time. The suboptimal performance metric applicable to this use case may be the latencies incurred for repeatedly missed payments of invoices over the predefined period of time.

As a fourth illustrative example, a rate plan change use case is described. In this use case, the service application 133 may use the identification application 173 and an identification policy 142 to identify a user (one or more users) that changes the rate plan in a subscription plan 161 of the user over a predefined period of time above a threshold frequency, as indicated in the current user parameters 303 and the subscription plan 161 of the user. The identification policy 142 applicable to this use case may define the threshold frequency in which the user has repeatedly changed the rate plan over the predefined period of time. The suboptimal performance metric applicable to this use case may be the latencies incurred for frequently changing the rate plan for the user over the predefined period of time.

At operation 330, the service application 133 may use the user grouping application 176 to identify multiple other users exhibiting a similar suboptimal performance metric based on the current user parameters 303 of the users (collected over a period of time) and a user grouping policy 145. Again, the user grouping application 176 may be trained to identify the users exhibiting the similar suboptimal performance metric based on an evaluation of the current user parameters 303 of all of the users. The user grouping policy 145 applicable to this use case may define thresholds for determining whether the users exhibit the similar suboptimal performance metric.

Referring back to the international long distance call use case, the service application 133 may use the user grouping application 176 to identify multiple other users based on the suboptimal performance metric that is the payment or cost incurred for the minutes-per-month range of international long distance calls. For example, the service application 133 may use the user grouping policy 145 to identify multiple other users that are paying at least a threshold amount more for a minutes-per-month range of international long distance calls compared to a subset of other users that are paying less than the threshold amount for the same minutes-per-month range of international long distance calls.

Referring back to the maximum data usage use case, the service application 133 may use the user grouping application 176 to identify multiple other users based on the suboptimal performance metric of the latencies incurred for repeatedly exceeding the maximum allotted data usage amount over the predefined period of time. For example, the service application 133 may use the user grouping application 176 to identify multiple other users that are exceeding the maximum allotted data usage amount for the other users over a predefined period of time above a threshold frequency, as defined in the user grouping policy 145.

Referring back to the missed payment use case, the service application 133 may use the user grouping application 176 to identify multiple other users based on the suboptimal performance metric of the latencies incurred for repeatedly missed payments of invoices over the predefined period of time. For example, the service application 133 may use the user grouping application 176 to identify multiple other users that have repeatedly missed payments of invoices and in some cases, had a suspended account, for a predefined period of time above a threshold frequency, as defined in the user grouping policy 145.

Referring back to the rate plan change use case, the service application 133 may use the user grouping application 176 to identify multiple other users based on the suboptimal performance metric of the latencies incurred for frequently changing the rate plan for the user over the predefined period of time. For example, the service application 133 may use the user grouping application 176 to identify multiple other users that have frequently changed the rate plan in a subscription plan 161 of the user over a predefined period of time above a threshold frequency, as defined in the user grouping policy 145.

At operation 335, the service application 133 may use the recommendation application 179 to determine a service package application to recommend to the users based on the current user parameters 303 of the users (collected over a period of time) and a service policy 148. Again, the recommendation application 179 may be trained to determine the service package to recommend to the users based on an evaluation of the available service packages (e.g., as indicated in an NPE catalog 126) and the suboptimal performance metric associated with the users. For example, a service policy 148 may indicate one or more service packages may have a history of helping mitigate the suboptimal performance metrics (e.g., decreasing latencies and/or decreasing costs).

Referring back to the international long distance call use case, the service application 133 may use the recommendation application 179 to determine a service package to mitigate or resolve the inefficiencies caused by the suboptimal performance metric associated with the users (i.e., reduce the international long distance calls for the users). For example, the service application 133 may use the recommendation application 179 and a service policy 148 to determine a service package (e.g., an add-on feature that may be added to subscription plans 161 of the users) that has a history of reducing the costs incurred by the user for international long distance calls (thereby mitigating the suboptimal performance metric of the users).

Referring back to the maximum data usage use case, the service application 133 may use the recommendation application 179 to determine a service package to mitigate or resolve the inefficiencies caused by the suboptimal performance metric associated with the network (i.e., latencies incurred for repeatedly exceeding the maximum allotted data usage amount over the predefined period of time). For example, the service application 133 may use the recommendation application 179 and a service policy 148 to determine a service package (e.g., modifying the subscription plan 161 to increase the allotted data usage amount for the users) that has a history of reducing latencies and costs for the users (thereby mitigating the suboptimal performance metric of the users).

Referring back to the missed payment use case, the service application 133 may use the recommendation application 179 to determine a service package to mitigate or resolve the inefficiencies caused by the suboptimal performance metric associated with the network (i.e., latencies incurred for repeatedly missed payments of invoices over the predefined period of time). For example, the service application 133 may use the recommendation application 179 and a service policy 148 to identify and determine a service package (e.g., modifying the subscription plan 161 to be a pre-paid plan instead of a postpaid plan) that has a history of reducing latencies and costs for the users (thereby mitigating the suboptimal performance metric of the users).

Referring back to the rate plan change use case, the service application 133 may use the recommendation application 179 to determine a service package to mitigate or resolve the inefficiencies caused by the suboptimal performance metric associated with the network (i.e., latencies incurred for frequently changing the rate plan for the user over the predefined period of time). For example, the service application 133 may use the recommendation application 179 and a service policy 148 to determine a service package (e.g., modifying the subscription plan to be an optimal rate plan for the user based on a history of usage of the user) that has a history of reducing latencies and costs for the users (thereby mitigating the suboptimal performance metric of the users).

At operation 340, the service application 133 may use the simulation application 182 to simulate adding the service package to the subscription plan 161 of each of the users to determine a cost parameter 157 for each of the users based on the current user parameters 303 of the users (collected over a period of time) and a modification policy 151. Again, the simulation application 182 may be trained to simulate how the addition of the service package to the subscription plans 161 may mitigate the suboptimal performance metric of the users based on a modification policy 151 (e.g., possibly increasing the performance metric to a value above a threshold defined in a modification policy 151). For example, a modification policy 151 may define that the simulation is to be performed over a period of time, and the period of time may be based on the suboptimal performance metric. The modification policy 151 may also indicate a threshold by which to compare the cost parameters 157 for the users, based on the suboptimal performance metric, to determine whether to recommend the service package to the user or not.

Referring back to the international long distance call use case, the service application 133 may use the simulation application 182 to simulate the addition of the service package to the subscription plan 161 of the users to identify the cost parameters 157, which may indicate a quantity by which the suboptimal performance metric is mitigated by the addition of the service package. For example, the service application 133 may use the simulation application 182 to simulate the addition of the service package (e.g., an add-on feature that may be added to subscription plans 161 of the users) over the period of time as defined by the modification policy 151 to determine a cost parameter 157 of the user. The service application 133 (in some cases, using the simulation application 182) may determine whether the cost parameter 157 of the user exceeds a threshold defined in the modification policy 151, to determine whether to recommend the service package to a client 103 of the user.

Referring back to the maximum data usage use case, the service application 133 may use the simulation application 182 to simulate the addition of the service package (e.g., modifying the subscription plan to increase the allotted data usage amount for the users) over the period of time as defined by the modification policy 151 to determine a cost parameter 157 of the user. The service application 133 (in some cases, using the simulation application 182) may determine whether the cost parameter 157 of a user exceeds a threshold defined in the modification policy 151, to determine whether to recommend the service package to a client 103 of the user.

Referring back to the missed payment use case, the service application 133 may use the simulation application 182 to simulate the addition of the service package (e.g., modifying the subscription plan to be a pre-paid plan instead of a postpaid plan) over the period of time as defined by the modification policy 151 to determine a cost parameter 157 of the user. The service application 133 (in some cases, using the simulation application 182) may determine whether the cost parameter 157 of a user exceeds a threshold defined in the modification policy 151, to determine whether to recommend the service package to a client 103 of the user.

Referring back to the rate plan change use case, the service application 133 may use the simulation application 182 to simulate the addition of the service package (e.g., modifying the subscription plan to be an optimal rate plan for the user based on a history of usage of the user) over the period of time as defined by the modification policy 151 to determine a cost parameter 157 of the user. The service application 133 (in some cases, using the simulation application 182) may determine whether the cost parameter 157 of a user exceeds a threshold defined in the modification policy 151, to determine whether to recommend the service package to a client 103 of the user.

When the service application 133 determines that the cost parameter 157 of the user exceeds a threshold defined in the modification policy 151 (e.g., associated with the suboptimal performance metric), the service application 133 may determine to send an offer of the service package to the user. In particular, the service application 133 may be triggered to send a notification comprising service package data 159 describing the service package to the clients 103 of the users that have the cost parameter 157 exceeding the threshold. The notification may be formatted as message carrying details regarding the service package as indicated in the service package data 159 and instructions on how to present the service package to the user as an offer (e.g., as a pop-up notification, as a marketing advertisement on a live application, as an alert for the user, an addition to a dashboard displayed on the client 103, etc.).

The client 103 may receive the notification, and the client application 118 may display a representation of the service package as an offer for the user on a display of the client 103. The user may interact with the user interface 119 to express different levels of interest in the service package (e.g., decline the offer, accept the offer, indicate a desire to view more information about the service package, indicate a request to modify the service package, etc.). Each of the different levels of interest may be associated with a different weight parameter 224, which may be carried back to the data model system 109 as feedback data 154 to retrain the machine learning models 170 that operate with the identification application 173, user grouping application 176, recommendation application 179, and simulation application 182, to continuously improve the efficiency and accuracy of the data model system 109.

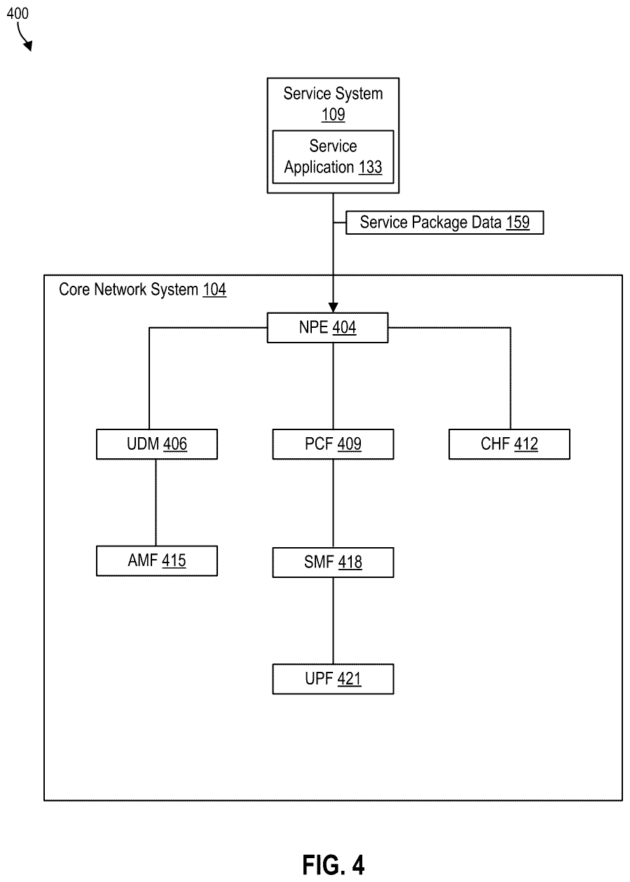

When the user accepts the offer, the user may for example select a link via the user interface 119 to accept the offer and the conditions for consideration (e.g., payment) for the service package. The acceptance of the offer may be transmitted as a message back to the service application 133, again as feedback data 154, which may be used to provision the service package in the subscription plan 161 of the user, as further described below with reference to FIG. 4.

Referring now to FIG. 4, shown is a diagram 400 of provisioning or deploying a service package to a subscription plan 161 of a user after the user has accepted the offer of the subscription plan 161. As shown in FIG. 4, the example core network system 104 shown in FIG. 4 includes various core network applications 116 or elements, including the network provisioning entity (NPE) 404, the unified data management (UDM) 406, the policy control function (PCF) 409, the call handling function (CHF) 412, the access and mobility management function (AMF) 415, the session management function (SMF) 418, and one or more user plane functions (UPFs) 421. As should be appreciated, the core network applications 116 or elements illustrated in FIG. 4 are not exclusive, and the core network system 104 may include numerous other core network applications 116 and elements not otherwise illustrated in FIG. 4.

After the service system 106 receives the feedback data 154 from the client 103 indicating acceptance of the offer, the service application 133 may transmit service package data 159 describing the accepted service package to the core network system 104. In an embodiment, the service package data 159 may be sent to the NPE 404 in a provisioning request. The NPE 404 may verify the request against the NPE catalog 126 to check for feature compatibility of the client 103 with the service package, network resource availability, business rule compliance, etc. The NPE 404 may decompose the service package data 159 into specific configuration actions and interact with the other core network applications 116 based on a feature type of the service package. For example, the NPE 404 may interact with a home subscriber server (HSS) to update a subscriber profile of the user for service package activation, may interact with a PCF 409 to update policy rules for service package enforcement, may interact with an online charging system (OCS) to apply charging rules, usage limits, or balance deductions, may interact with a subscriber to store a service package enablement status, may interact with one or more application servers if the service package requires additional enablement, etc.

The NPE 404 may update subscriber profiles at the UDM 406. The PCF 409 may apply policy changes, such as QoS enforcement and access rules. The CHF 412 may update billing information to ensure correct charging for the service package. The AMF 415 may synchronize subscriber information for mobility and session handling. The SMF 418 may enforce the new service policies to enable the service package features in active sessions. The UPF 421 may enforce data path rules to ensure the user experiences the provisioned service package. Therefore, once provisioning is completed, the HSS may update the user profile with the new service package, the PCF 409 may enforce new policies associated with the service package, the OCS may update charging logic to reflect pricing of the service package, etc. Lastly, the client may be notified of the successful provisioning and deployment of the service package with respect to the subscription plan 161 of the user.

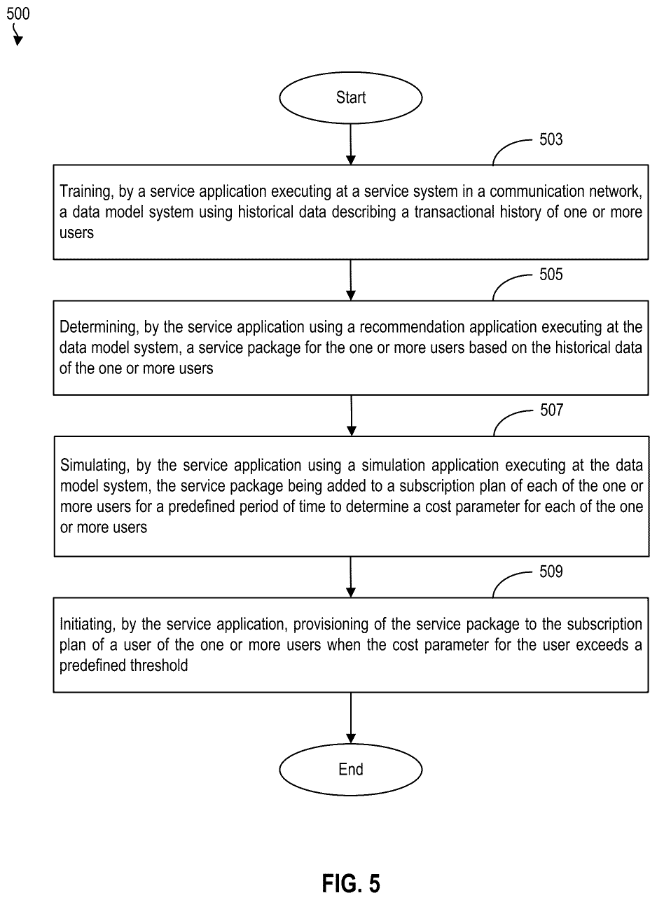

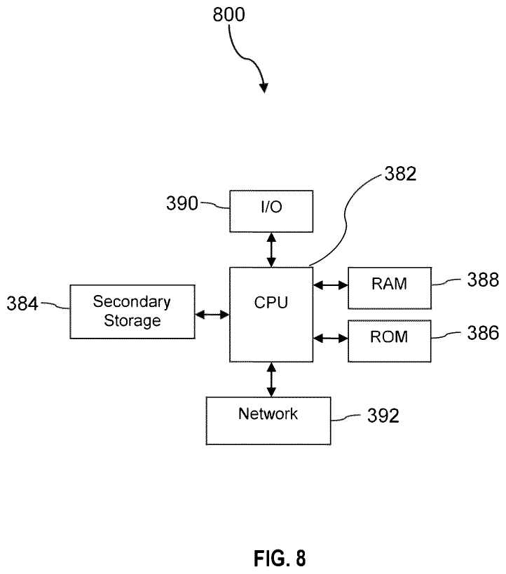

Referring now to FIG. 5, shown is a method 500 of optimal service package determination and deployment in the communication network 100 of FIG. 1 according to various embodiments of the disclosure. Method 500 may be implemented by the service application 133 in the service system 106 using the data model system 109. In embodiments, the method 500 may be implemented using a computer system with components as shown in FIG. 8. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises training, by a service application 133 executing at a service system 106 in a communication network 100, a data model system 109 using historical data 203 describing a transactional history of one or more users. At step 505, method 500 comprises determining, by the service application 133 using a recommendation application 179 executing at the data model system 109, a service package for the one or more users based on the historical data 203 of the one or more users. At step 507, method 500 comprises simulating, by the service application 133 using a simulation application 182 executing at the data model system 109, the service package being added to a subscription plan 161 of each of the one or more users for a predefined period of time to determine a cost parameter 157 for each of the one or more users. At step 509, method 500 comprises initiating, by the service application 133, provisioning of the service package to the subscription plan 161 of a user of the one or more users when the cost parameter 157 for the user exceeds a predefined threshold.

Method 500 may include other steps and/or features that are not otherwise shown in FIG. 5. In an embodiment, the historical data 203 comprises service package records 209 describing a history of service packages associated with the one or more users and usage records 212 describing at least one of service usage, applied rates, balance adjustments, or session details of the one or more users. In an embodiment, the service package records 209 and the usage records 212 are obtained from at least one of call detail records 120 of the one or more users collected of a prior predefined period of time, charging system metered data 122 of the one or more users collected over the prior predefined period of time, a charging subscription record query log 124 of the one or more users collected over the prior predefined period of time, a network provisioning entity catalog 126 of service packages, a network provisioning entity provisioning log 128 for the one or more users collected over the prior predefined period of time, a network usage record 130 for the one or more users collected over the prior predefined period of time, or a network service management log 131 for the one or more users collected over the prior predefined period of time.

In an embodiment, method 500 may further comprise determining, by the service application 133 using a user grouping application 176 of the data model system 109, the one or more users based on the one or more users having a similar transactional history as indicated in the historical data 203 used to train the data model system 109. In an embodiment, the transaction history of the one or more users indicates that the one or users conduct over a first threshold amount of international long distance calls over repeated, consecutive periods of time, and wherein service package comprises an add-on feature to the subscription plan 161 of each of the one or more users to reduce a cost of international long distance calls. In an embodiment, the transaction history of the one or more users indicates that each of the one or more users has reached a predefined usage threshold for voice calls or data consumption as indicated in the subscription of each of the one or more users, and the service package comprises an offer to increase the predefined usage threshold for each of the one or more users based on the historical data describing prior voice calls or data consumption each of the one or more users. In an embodiment, the transaction history of the one or more users indicates that an account each of the one or more users has been suspended at least a threshold quantity of times of during predefined period of time, and the service package comprises at least one an offer to downgrade the subscription plan 161 for each of the one or more users or an offer to switch each of the one or more users to a prepaid subscription plan.

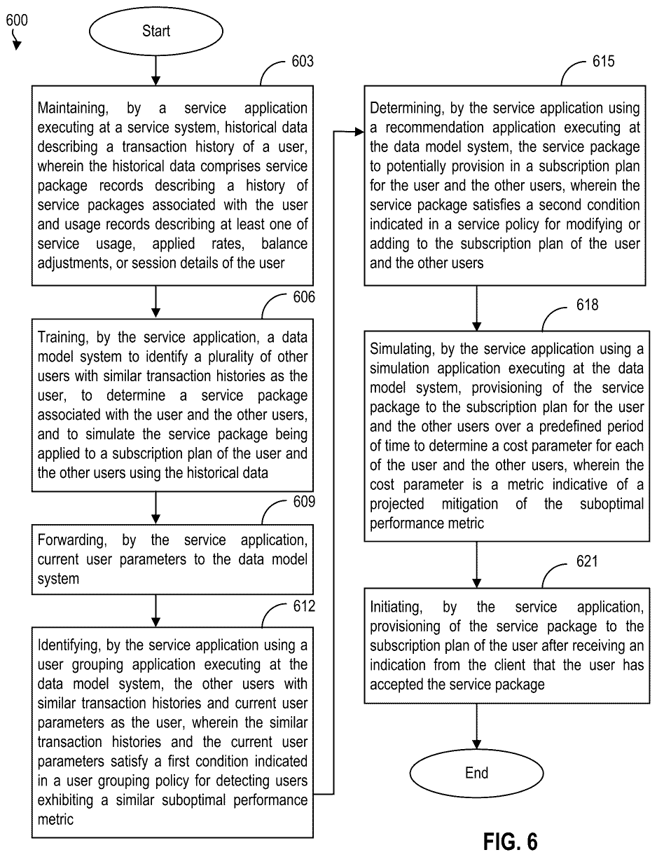

Referring now to FIG. 6, shown is a method 600 of optimal service package determination and deployment in the communication network 100 of FIG. 1 according to various embodiments of the disclosure. Method 600 may be implemented by the service application 133 in the service system 106 using the data model system 109. In embodiments, the method 600 may be implemented using a computer system with components as shown in FIG. 8. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 comprises maintaining, by a service application 133 executing at a service system 106, historical data 203 describing a transaction history of a user, in which the historical data 203 comprises service package records 209 describing a history of service packages associated with the user and usage records 212 describing at least one of service usage, applied rates, balance adjustments, or session details of the user. At step 606, method 600 comprises training, by the service application, a data model system 109 to identify a plurality of other users with similar transaction histories as the user, to determine a service package associated with the user and the other users, and to simulate the service package being applied to a subscription plan of the user and the other users using the historical data. At step 609, method 600 comprises forwarding, by the service application 133, current user parameters 303 to the data model system 109.

At step 612, method 600 comprises identifying, by the service application 133 using a user grouping application 176 executing at the data model system 109, the other users with similar transaction histories and current user parameters 303 as the user, in which the similar transaction histories and the current user parameters 303 satisfy a first condition indicated in a user grouping policy 145 for detecting users exhibiting similar suboptimal performance metrics. At step 615, method 600 comprises determining, by the service application 133 using a recommendation application 179 executing at the data model system 109, the service package to potentially provision in a subscription plan 161 for the user and the other users. The service package may satisfy a second condition indicated in a service policy 148 for modifying or adding to the subscription plan of the user and the other users.

At step 618, method 600 comprises simulating, by the service application 133 using a simulation application 182 executing at the data model system 109, provisioning of the service package to the subscription plan 161 for the user and the other users over a predefined period of time to determine a cost parameter 157 for each of the user and the other users. In an embodiment, the cost parameter 157 is a metric indicative of a projected mitigation of the suboptimal performance metric. At step 621, method 600 comprises initiating, by the service application 133, provisioning of the service package to the subscription plan 161 of the user after receiving an indication from the client 103 that the user has accepted the service package.

Method 600 may include other steps and/or features that are not otherwise shown in FIG. 6. In an embodiment, method 600 may comprise receiving, by the service application 133 from the client 103, a message with the indication that the user has accepted the service package to be added to the subscription plan 161 of the user, determining, by the service application 133, a weight parameter 224 associated with the user based on the user having accepted the service package, and transmitting, by the service application 133 to the data model system 109, the weight parameter 224 in association with an identification of the user to retrain the data model system 109 to indicate an accuracy of the service package recommended for the user.

In an embodiment, method 600 may further comprise receiving, by the service application 133 from the client 103, a message with a second indication that the user has selected an option to view more details regarding the service package, determining, by the service application 133, a weight parameter 224 associated with the user based on the user having indicated an interest in the service package, and transmitting, by the service application 133 to the data model system 109, the weight parameter 224 in association with an identification of the user to retrain the data model system 109 to indicate an accuracy of the service package recommended for the user.

In an embodiment, the service package records 209 and the usage records 212 are obtained from at least one of call detail records 120 of the user and the other users collected over a prior predefined period of time, charging system metered data 122 of the user and the other users collected over the prior predefined period of time, a charging subscription record query log 124 of the user and the other users collected over the prior predefined period of time, a network provisioning entity catalog 126 of service packages, a network provisioning entity provisioning log 128 for the user and the other users collected over the prior predefined period of time, a network usage record 130 for the user and the other users collected over the prior predefined period of time, or a network service management log 131 for the user and the other users collected over the prior predefined period of time. In an embodiment, the service package comprises a new service, a service modification, or an add-on feature that is capable of being dynamically provisioned to the subscription plan 131 of the user. In an embodiment, initiating, by the service application 133, provisioning of the service package to the subscription plan 161 of the user comprises transmitting, by the service application 133, an instruction to a NPE 404 in the core network system 104. The instruction may include an identification of the user and service package data describing the service package.

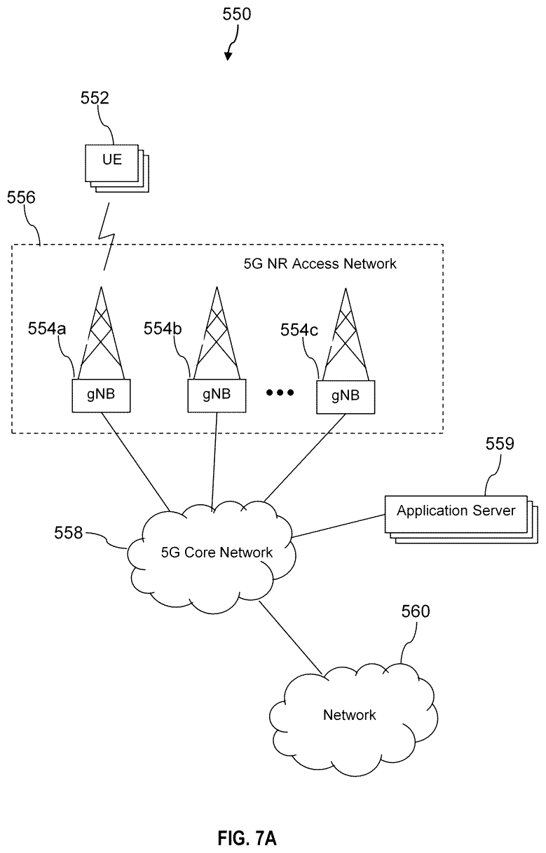

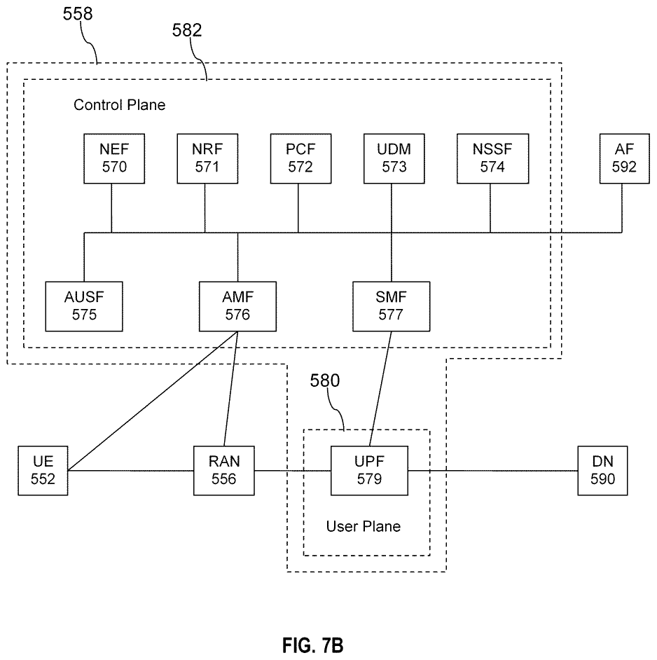

Turning now to FIG. 7A, an exemplary communication system 550 is described. In an embodiment, the communication system 550 may be implemented in the network 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices (whether or not user operated), or devices such as clients 103, can operate. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 7B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 7A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 8 illustrates a computer system 800 suitable for implementing one or more embodiments disclosed herein. In an embodiment, the clients 103, core network system 104, service system 106, data model system 109, and/or data stores 112, etc., may each be implemented as the computer system 800. The computer system 800 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 800, at least one of the CPU 382, the RAM 388, and the ROM 386 are changed, transforming the computer system 800 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 800 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 384, to the ROM 386, to the RAM 388, and/or to other non-volatile memory and volatile memory of the computer system 800. The processor 382 may process the executable instructions and/or data structures in part by directly accessing the computer program product, for example by reading from a CD-ROM disk inserted into a disk drive peripheral of the computer system 800. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 800.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method for optimal service package determination and deployment in a communication network, wherein the method comprises:
maintaining, by a service application executing at a service system, historical data describing a transaction history of a user, wherein the historical data comprises service package records describing a history of service packages associated with the user and usage records describing at least one of service usage, applied rates, balance adjustments, or session details of the user;
training, by the service application, a data model system to identify a plurality of other users with similar transaction histories as the user, to determine a service package associated with the user and the other users, and to simulate the service package being applied to a subscription plan of the user and the other users using the historical data;
forwarding, by the service application, current user parameters to the data model system;
identifying, by the service application using a user grouping application executing at the data model system, the other users with similar transaction histories and current user parameters as the user, wherein the similar transaction histories and the current user parameters satisfy a first condition indicated in a user grouping policy for detecting users exhibiting a similar suboptimal performance metric;
determining, by the service application using a recommendation application executing at the data model system, the service package to potentially provision in a subscription plan for the user and the other users, wherein the service package satisfies a second condition indicated in a service policy for modifying or adding to the subscription plan of the user and the other users;
simulating, by the service application using a simulation application executing at the data model system, provisioning of the service package to the subscription plan for the user and the other users over a predefined period of time to determine a cost parameter for each of the user and the other users, wherein the suboptimal performance metric comprises a network performance metric that deviates from a predefined operational threshold, and the cost parameter is a metric indicative of a projected correction to the network performance metric resulting from the simulated provisioning;
determining, by the service application, that the cost parameter for the user exceeds a predefined threshold;
transmitting, by the service application, a notification describing the service package to a client associated with the user in response to determining that the cost parameter for the user exceeds the predefined threshold;
receiving, by the service application from the client, the indication that the user has accepted the service package; and
initiating, by the service application, provisioning of the service package to the subscription plan of the user in response to receiving the indication by transmitting a provisioning request to a network provisioning entity in a core network system, the provisioning request causing the network provisioning entity to update at least one subscriber profile or policy rule in the core network system to activate the service package.

2. The method of claim 1, further comprising:
receiving, by the service application from the client, a message with the indication that the user has accepted the service package to be added to the subscription plan of the user;
determining, by the service application, a weight parameter associated with the user based on the user having accepted the service package; and
transmitting, by the service application to the data model system, the weight parameter in association with an identification of the user to retrain the data model system to indicate an accuracy of the service package recommended for the user.

3. The method of claim 1, further comprising:
receiving, by the service application from the client, a message with a second indication that the user has selected an option to view more details regarding the service package;
determining, by the service application, a weight parameter associated with the user based on the user having indicated an interest in the service package; and
transmitting, by the service application to the data model system, the weight parameter in association with an identification of the user to retrain the data model system to indicate an accuracy of the service package recommended for the user.

4. The method of claim 1, wherein the service package records and the usage records are obtained from at least one of call detail records of the user and the other users collected over a prior predefined period of time, charging system metered data of the user and the other users collected over the prior predefined period of time, a charging subscription record query log of the user and the other users collected over the prior predefined period of time, a network provisioning entity catalog of service packages, a network provisioning entity provisioning log for the user and the other users collected over the prior predefined period of time, a network usage record for the user and the other users collected over the prior predefined period of time, or a network service management log for the user and the other users collected over the prior predefined period of time.

5. The method of claim 1, wherein the service package comprises a new service, a service modification, or an add-on feature that is capable of being dynamically provisioned to the subscription plan of the user.

6. The method of claim 1, wherein initiating, by the service application, provisioning of the service package to the subscription plan of the user comprises transmitting, by the service application, an instruction to a network provisioning entity in a core network system, wherein the instruction includes an identification of the user and service package data describing the service package.

7. A system, comprising:
a non-transitory memory configured to:
store historical data describing a transaction history of a plurality of users, wherein the historical data comprises service package records describing a history of service packages associated with each of the users and usage records describing at least one of service usage, applied rates, balance adjustments, or session details of each of the users; and
store a subscription plan associated with each of the users;
a processor communicatively coupled to the memory; and
a service application stored at the memory, which when executed by the processor, causes the processor to be configured to:
train a data model system to identify a subset of users with similar transaction histories, to determine a service package associated with the subset of users, and to simulate the service package being applied to a subscription plan of the subset of users using the historical data;
identify, using an identification application executing at the data model system, the subset of users with similar transaction histories based on current user parameters associated with the subset of users and first condition indicated in a user grouping policy for detecting users exhibiting a similar suboptimal performance metric;
simulate, using a simulation application executing at the data model system, provisioning of the service package to the subscription plan of the subset of users over a predefined period of time to determine a cost parameter for each of the subset of users, wherein the suboptimal performance metric comprises a network performance metric that deviates from a predefined operational threshold, and the cost parameter is a metric indicative of a projected correction to the network performance metric resulting from the simulated provisioning;
determine that the cost parameter of the user exceeds a predefined threshold;
receive an indication that the user accepts the service package; and
initiate provisioning of the service package to the subscription plan of a user in response to determining that the cost parameter exceeds the predefined threshold and receiving the indication by transmitting a provisioning request to a network provisioning entity in a core network system, the provisioning request causing the network provisioning entity to update at least one subscriber profile or policy rule in the core network system to activate the service package.

8. The system of claim 7, wherein the service application is further configured to determine the service package to potentially provision in the subscription plan for the subset of users, wherein the service package satisfies a second condition indicated in a service policy for modifying or adding to the subscription plan of the subset of users.

9. The system of claim 7, wherein the service application is further configured to transmit a notification describing the service package to a client associated with the user when the cost parameter for the user exceeds the predefined threshold.

10. The system of claim 7, wherein the service application is further configured to:
receive a first indication that the user has accepted the service package to be added to the subscription plan of the user or a second indication that the user has selected an option to view more details regarding the service package; and
determine a weight parameter of the user based on whether the user has accepted the service package or whether the user has selected the option to view more details regarding the service package.

11. The system of claim 10, wherein the service application is further configured to transmit the weight parameter in association with an identification of the user to the data model system to retrain the data model system to indicate an accuracy of the service package recommended for the user.

12. The system of claim 7, wherein the service package records and the usage records are obtained from at least one of call detail records of the users collected over a prior predefined period of time, charging system metered data of the users collected over the prior predefined period of time, a charging subscription record query log of the users collected over the prior predefined period of time, a network provisioning entity catalog of service packages, a network provisioning entity provisioning log for the users collected over the prior predefined period of time, a network usage record for the users collected over the prior predefined period of time, or a network service management log for the users collected over the prior predefined period of time.

13. The system of claim 8, wherein the service package comprises a new service, a service modification, or an add-on feature that is capable of being dynamically provisioned to the subscription plan of the user.

14. A method comprising:
training, by a service application executing at a service system in a communication network, a data model system using historical data describing a transactional history of one or more users;
to determine to determine a cost parameter for each of the one or more users that is indicative of a projected correction to the suboptimal network performance metric resulting from the simulated addition of the service package;
determining, by the service application, that the cost parameter for the user exceeds a predefined threshold; and
initiating, by the service application, provisioning of the service package to the subscription plan of a user of the one or more users in response to determining that the cost parameter exceeds the predefined threshold by transmitting a provisioning request to a network provisioning entity in a core network system, the provisioning request causing the network provisioning entity to update at least one subscriber profile or policy rule in the core network system to activate the service package.

15. The method of claim 14, wherein the historical data comprises service package records describing a history of service packages associated with the one or more users and usage records describing at least one of service usage, applied rates, balance adjustments, or session details of the one or more users.

16. The method of claim 15, wherein the service package records and the usage records are obtained from at least one of call detail records of the one or more users collected of a prior predefined period of time, charging system metered data of the one or more users collected over the prior predefined period of time, a charging subscription record query log of the one or more users collected over the prior predefined period of time, a network provisioning entity catalog of service packages, a network provisioning entity provisioning log for the one or more users collected over the prior predefined period of time, a network usage record for the one or more users collected over the prior predefined period of time, or a network service management log for the one or more users collected over the prior predefined period of time.

17. The method of claim 14, further comprising determining, by the service application using a user grouping application executing at the data model system, the one or more users based on the one or more users having a similar transactional history as indicated in the historical data used to train the data model system.

18. The method of claim 14, wherein the transaction history of the one or more users indicates that the one or users conduct over a first threshold amount of international long distance calls over repeated, consecutive periods of time, and wherein the service package comprises an add-on feature to the subscription plan of each of the one or more users to reduce a cost of international long distance calls.

19. The method of claim 14, wherein the transaction history of the one or more users indicates that each of the one or more users has reached a predefined usage threshold for voice calls or data consumption as indicated in the subscription plan of each of the one or more users, and wherein the service package comprises an offer to increase the predefined usage threshold for each of the one or more users based on the historical data describing prior voice calls or data consumption each of the one or more users.

20. The method of claim 14, wherein the transaction history of the one or more users indicates that an account each of the one or more users has been suspended at least a threshold quantity of times during a period of time, and wherein the service package comprises at least one of an offer to downgrade the subscription plan for each of the one or more users or an offer to switch each of the one or more users to a prepaid subscription plan.
